(19) United States
(12) Patent Application Publication
(10) Pub. No.: US 2016/0036122 A1
(43) Pub. Date: Feb. 4, 2016

(54) ELECTROMAGNETIC WAVE DETECTION/GENERATION DEVICE AND METHOD FOR MANUFACTURING SAME

(71) Applicant: CANON KABUSHIKI KAISHA, Tokyo (JP)

(72) Inventor: Alexis Debray, Tokyo (JP)

(21) Appl. No.: 14/811,105

(22) Filed: Jul. 28, 2015

(30) Foreign Application Priority Data
Jul. 29, 2014 (JP) 2014-154354

(51) Int. Cl. H01Q 1/36; G01J 1/42; G21K 5/02

(52) U.S. Cl. CPC H01Q 1/36; G21K 5/02; G01J 1/42

(57) ABSTRACT

An electromagnetic wave detection/generation device including a substrate, and a plurality of reception/radiation elements provided on the substrate. In the electromagnetic wave detection/generation device, the plurality of reception/radiation elements each include an antenna and an electronic device, at least two of the reception/radiation elements are coated at least partially with dielectric layers, the dielectric layers each having a function of adjusting a frequency response characteristic of the antenna of the corresponding one of the reception/radiation elements, and at least two of the dielectric layers are different with respect to each other in at least either one of thickness, material, shape, and coating ratio.

### BACKGROUND OF THE INVENTION

1. Field of the Invention

The present invention relates to an electromagnetic wave detection/generation device including a plurality of electromagnetic wave reception/radiation elements in which frequency response characteristics such as resonance frequencies are adjusted or corrected and to a method for manufacturing the same. Note that in the present invention, “detection/generation” refers to performing at least either one of the electromagnetic wave detection and the electromagnetic wave generation. Furthermore, “reception/radiation” refers to performing at least either one of the electromagnetic wave reception and the electromagnetic wave radiation.

2. Description of the Related Art

An imaging device for a terahertz range can be configured by arranging a plurality of sensors for a terahertz range into an array form and disposing a suitable focus lens. Such an imaging device for a terahertz range is useful in various technical fields. Since the terahertz wave does not easily transmit through metal but transmits through structures such as a fiber structure, the above imaging device can be used for security such as detecting a hidden weapon, for example. In another example, since a healthy body tissue and a cancer tissue have different refractive indexes with respect to an electromagnetic wave of a terahertz range, by image forming, the existence of a cancer cell can be detected. Such an imaging device can be used in a medical field.

The potential usefulness of image forming using a terahertz wave exists in various technical fields; however, in order to actually put it to practical use, a few requirements, such as appropriately defining the frequency of the electromagnetic wave used in obtaining an image, need to be satisfied. For example, the difference in the refractive indexes between a heathy cell and a cancer cell is more significant at a certain frequency than at other frequencies. Another example is imaging of a specific molecule that has a predetermined rotation spectrum in the terahertz range. In such a case, if the sensor has a sensitivity in a specific frequency region, then, it will be possible to form an image of the above molecule alone. Typically, due to a physical reason, a resonant detector that has a sensitivity in the narrow band has a higher sensitivity compared to a nonresonant detector that has a sensitivity in the broadband. From the above points, when designing a sensor for a specific purpose, the operating frequency band needs to be adjusted minutely.

Owing to progress in recent years, a bolometer and a rectifying device for a terahertz range can be integrated on a sensor of a semiconductor substrate; however, the size of each elements changes in accordance with the wavelength. For example, since the wavelength of 1 THz is about 300 μm, in a sensor of 3 cm^{2, 10,000} (100′100) elements can be integrated as a structural unit. On the other hand, as described above, in a sensor for a terahertz range, there may be a need to adjust the resonance frequency of the narrow band of the resonant detector. Naturally, the adjustment of the resonance frequency is carried out through design; however, across the entire structural unit, errors such as an error in the fabrication dimension cannot be prevented with the conventional semiconductor producing techniques. Other than by normal distortion that occurs during a physical process, the errors are in some cases caused by inherent distortion that is associated with the semiconductor producing techniques.

The description of U.S. Pat. No. 7,518,560 discloses a method for adjusting a resonance frequency of an antenna and an antenna that has been adjusted with the method. In the disclosure, in order to adjust the resonance frequency to a target resonance frequency, a radiation element of the antenna is coated with a dielectric layer and the thickness and the surface area are adjusted to make the resonance frequency of the antenna be the same as the target resonance frequency. The adjustment method includes a step of measuring the actual resonance frequency of the antenna, a step of covering the radiation element with a dielectric layer, and a step of adjusting the thickness and area of the dielectric layer. The above steps are repeated until the measured resonance frequency reaches the target resonance frequency. Although the technique is effective in fabricating an antenna having the target resonance frequency, it is considerably time consuming even in a case in which there is only one element. In a case in which there is a number of (more than a few thousand or a few million, for example) antennas, since the plurality of dielectric layers need to have different thicknesses with respect to each other, adjustment is not easy. Forming dielectric layers with a plurality of different thicknesses using a deposition technique and a patterning technique of the dielectric layer (normally, including photolithography and etching processes) is a considerably complicated process.

### SUMMARY OF THE INVENTION

An electromagnetic wave detection/generation device according to an aspect of the present invention includes a substrate, and a plurality of reception/radiation elements provided on the substrate. In the electromagnetic wave detection/generation device, the plurality of reception/radiation elements each include an antenna and an electronic device, at least two of the reception/radiation elements are coated at least partially with dielectric layers, the dielectric layers each having a function of adjusting a frequency response characteristic of the antenna of the corresponding one of the reception/radiation elements, and at least two of the dielectric layers are different with respect to each other in at least either one of thickness, material, shape, and coating ratio. Further features of the present invention will become apparent from the following description of exemplary embodiments with reference to the attached drawings.

### BRIEF DESCRIPTION OF THE DRAWINGS

FIG. 1A is a plan view for describing a configuration of an exemplary electromagnetic wave detection/generation device of a first exemplary embodiment.

FIG. 1B is a cross-sectional view taken along IB-IB for describing the configuration of the exemplary electromagnetic wave detection/generation device of the first exemplary embodiment.

FIG. 2A is a graph illustrating frequency response characteristics of an antenna in which a substrate is not coated with a dielectric layer.

FIG. 2B is a graph illustrating frequency response characteristics of an antenna in which a substrate is coated with a dielectric layer.

FIG. 3 is a perspective view illustrating a model of an antenna that displays the characteristics of FIG. 2A.

FIG. 4A is a plan view for describing a configuration of an exemplary electromagnetic wave detection/generation device of a second exemplary embodiment.

FIG. 4B is a cross-sectional view taken along IVB-IVB for describing the configuration of the exemplary electromagnetic wave detection/generation device of the second exemplary embodiment.

FIG. 4C is a cross-sectional view taken along IVC-IVC for describing the configuration of the exemplary electromagnetic wave detection/generation device of the second exemplary embodiment.

FIG. 5A is a plan view for describing a configuration of an exemplary electromagnetic wave detection/generation device of a third exemplary embodiment.

FIG. 5B is a cross-sectional view taken along VB-VB for describing the configuration of the exemplary electromagnetic wave detection/generation device of the third exemplary embodiment.

FIG. 6A is a plan view for describing a front side configuration of an exemplary electromagnetic wave detection/generation device of a fourth exemplary embodiment.

FIG. 6B is a cross-sectional view taken along VIB-VIB for describing the configuration of the exemplary electromagnetic wave detection/generation device of the fourth exemplary embodiment.

FIG. 6C is a bottom view for describing a backside configuration of an exemplary electromagnetic wave detection/generation device of the fourth exemplary embodiment.

FIG. 7 is a flowchart for describing an example of a manufacturing method of an electromagnetic wave detection/generation device of a fifth exemplary embodiment.

FIG. 8 is a flowchart for describing another example of a manufacturing method of an electromagnetic wave detection/generation device of a second example of the fifth exemplary embodiment.

### DESCRIPTION OF THE EMBODIMENTS

As described above, while it is possible to adjust the resonance frequency of the antenna to a desired value with the related art, when fabricating an image sensor including multiple antennas in the order of a few thousand, the fabrication process becomes very complicated and time consuming. Accordingly, in each of the exemplary embodiments hereinafter, description will be given of an electromagnetic wave detection/generation device in which the frequency response characteristics, such as resonance frequencies, of a plurality of antennas are adjusted or corrected and a method that enables such an electromagnetic wave detection/generation device to be manufactured in a relatively readily manner. Note that in the present description, “detection/generation” refers to performing at least either one of the electromagnetic wave detection and the electromagnetic wave generation. Furthermore, “reception/radiation” refers to performing at least either one of the electromagnetic wave reception and the electromagnetic wave radiation.

In each of the exemplary embodiments hereinafter, in an electromagnetic wave detection/generation device that includes a plurality of reception/radiation elements each including an antenna and an electronic device, there will be reception/radiation elements on which dielectric layers are provided in order to adjust the frequency response characteristics of the antennas. At least one of thicknesses, materials, shapes, and coating ratios (surface area coating ratios) of the dielectric layers are suitably determined. Typically, the dielectric layers are each separately provided on a corresponding one of at least two reception/radiation elements, that is, the antennas. Alternatively, the dielectric layers are formed on the other surface on the other side with respect to one of the sides of the substrate on which the plurality of reception/radiation elements are provided.

Hereinafter, the embodiments of the present invention will be described with reference to the drawings.

### First Exemplary Embodiment

An electromagnetic wave detection/generation device of a first exemplary embodiment operates at a frequency of a terahertz wave and a plurality of reception/radiation elements thereof includes resonance antennas. The resonance frequency of an antenna is mainly defined by a ratio between a speed of a current wave in a metal portion of the antenna and a characteristic length of the antenna. The characteristic length of the antenna is, for example, in a case of a half-wave length dipole antenna, the length of the metal portion. When the antenna is surrounded by vacuum, the speed of the current wave is the speed of light in vacuum. When a dielectric is in contact with the metal portion of the antenna, the speed of the current wave changes. The degree of change is related to the permittivity of the dielectric (hereinafter, also referred to as specific permittivity in order to make a comparison with the permittivity in vacuum), the thickness, the shape pattern, and the like. As a result, in a structure in which the dielectric is in contact with the metal portion of the antenna, the resonance frequency of the antenna changes.

The above change in resonance frequency is similar to the change in resonance frequency when the antenna is uniformly surrounded by a dielectric with a certain permittivity. The permittivity when the antenna is in contact with the dielectric may be called, from the viewpoint of the antenna, an effective dielectric constant. Other than a few metamaterials that have specific permittivities that are smaller than 1, generally, a specific permittivity of a material is larger than 1. A metamaterial is an artificial material that behaves in a manner not seen in materials of the natural world. Since the speed of the current wave is inversely proportional to the square root of the permittivity, the resonance frequency and the speed of a structure in which the metal portion of the antenna is in contact with the dielectric is always smaller than those of the antenna that is surrounded by vacuum. Accordingly, by having the metal portion of the antenna be in contact with the dielectric, the resonance frequency of the antenna can be made small.

The electromagnetic wave detection/generation device of the first exemplary embodiment is an image sensor that is an electromagnetic wave sensor for a terahertz range. The image sensor includes a semiconductor substrate that is provided with at least an array of a plurality of sensors, and each of the sensors includes an antenna and an electronic device. The antenna receives an electromagnetic wave, which has propagated through the exterior, through the sensor that is surrounded by a medium such as air and converts the electromagnetic wave into an electric signal, and the electric signal propagates through wiring and waveguides that are integrated on the semiconductor substrate. Furthermore, the electric signal is converted into a further suitable signal with the electronic device. For example, the frequency of the electric signal is converted to the low frequency side with a mixer. In such a case, the system needs a local oscillator. In another example, the electric signal is converted into a direct current signal with a rectifying device that is an electronic device. Schottky barrier diodes and plasmon field effect transistors are rectifying devices for a terahertz range. A sensor array for a terahertz range is capable of collecting information on spatial distribution of an image formed by a lens.

If the plurality of sensors of the array each have sensitivities to various frequencies, the same image can be obtained in these various frequencies. The above is a method that is the same as the method used in photographic techniques. In photographic techniques, pixels that have sensitivities to various colors (green, red, blue, etc.) are disposed in a single image sensor. In order for the antenna to effectively collect the electromagnetic wave exiting the image forming lens, a reception/radiation pattern of the antenna needs to be oriented towards the image forming lens. Since the permittivity of a semiconductor is by far larger than that of air, when an antenna is formed directly on a semiconductor substrate, most of the reception/radiation pattern of the antenna is oriented into the semiconductor substrate. In such a case, an electromagnetic wave mode of the semiconductor substrate is excited and a large distortion occurs in the detected image.

In order to avert such a situation from occurring, it is preferable to integrate a metal reflector on a portion of the semiconductor substrate under the antenna. In such a case, the reception/radiation pattern is mainly oriented upwards with respect to the semiconductor substrate. In such a case, in order to facilitate fabrication of the structure that mechanically holds the antenna, it is preferable to fill the space between the metal reflector and the antenna with a dielectric material. In the above case, the resonance frequency of the antenna is dependent on the permittivity of the dielectric filled between the metal reflector and the antenna as well.

Error of the actual resonance frequency of the antenna with respect to the design target value is caused by a fabrication error of the image sensor. Such an error is mainly related to an error that occurs in the course of fabrication of the sensor. As a result, the actual resonance frequencies of some antennas become different from the resonance frequency that is the target of the design. Such an error will be referred to as a frequency offset. Furthermore, it is common that the target resonance frequencies of a plurality of antennas are different from each other. In such a case, the degree of frequency offset is different in each of the antennas. In other words, there is a spatial distribution of the frequency offsets. In the present exemplary embodiment, in order to reduce the frequency offset of each antenna, each antenna is suitably coated with a dielectric layer to adjust the effective dielectric constant such that the frequency offset becomes substantially zero.

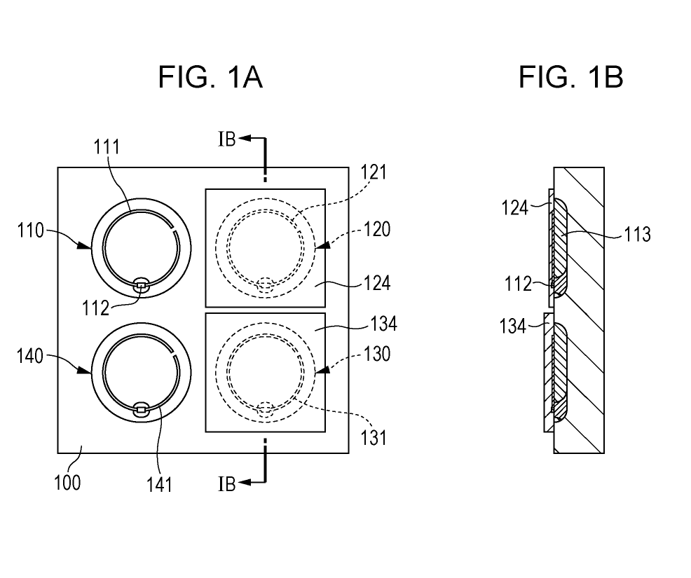

In a first example of the present exemplary embodiment, the same dielectric material entirely covers all of the antennas that have frequency offsets. The adjusting amount of the thickness of the dielectric layer differs according to the frequency offset amount of the antenna. FIG. 1A illustrates a top view of an electromagnetic wave detection/generation device of the first example and FIG. 1B illustrates a cross-sectional view taken along line IB-IB of FIG. 1A. An array of sensors 110, 120, 130, and 140 is provided in a planar semiconductor substrate 100. Each sensor includes at least a single antenna and an electronic device. Furthermore, the antenna is disposed above a reflector. In the sensor 110, reference numeral 111 is a loop shaped antenna, reference numeral 112 is an electronic device, and reference numeral 113 is a reflector. In the above, the resonance frequencies of the sensors 110 and 140 do not need to be corrected and, accordingly, the antennas 111 and 141 are not covered with a dielectric layer. Conversely, the resonance frequency of the antenna 121 needs to be corrected. Accordingly, the above antenna is coated with a dielectric layer 124 that has a predetermined thickness. Similarly, the resonance frequency of the antenna 131 needs to be corrected as well; however, the correction amount differs. Accordingly, the antenna 131 is coated with a dielectric layer 134 that is formed of a material that is the same as that of the dielectric layer 124 of the antenna 121 but with a thickness that is different from the dielectric layer 124.

The reflector 113 is formed by depositing metal on a bottom surface of a recessed portion formed in the semiconductor substrate 100; however, the reflector 113 is not formed in a base of a columnar portion supporting the electronic device 112. The columnar portion, on which the electronic device 112 is provided, is formed by growing the semiconductor on the bottom surface of the recessed portion through a window portion that is formed by cutting out a portion of the reflector 113. Herein, the antenna has a loop form and a cut is formed in order to prevent the rectified signal to be shunted. Other than the cut, a resistor, an inductor, and a capacitor may be inserted. In order to not disturb the current distribution, a cut may be preferably provided at a position where the electromagnetic field of the antenna is at its minimum. In such a case, compared with one that is not provided with a cut in the above manner, disturbance in the reception/radiation impedance can be suppressed. When the annular loop is excited near the second anti-resonance frequency, assuming that the angular position of the rectifying device is 0°, the minimum position of the electromagnetic field is at angular positions of 120° and 240°. However, the optimal position of the cut and the like generally depends on the existence of other elements such as the dielectric and the metal element in the vicinity of the loop.

From the viewpoint of ease of fabrication, it is desirable that the antennas that are to be adjusted are coated with a common dielectric material. In the fabrication process, first, a dielectric layer with a uniform thickness is deposited on the surface of the semiconductor substrate, for example. For example, spin coating or chemical vapor deposition (CVD) is used. The dielectric material in the terahertz range is, for example, silicon (specific permittivity: 12), silicon nitride (specific permittivity: 7), silicon dioxide (specific permittivity: 4), benzocyclobutene (BCB) (specific permittivity: 2.6), or parylene (specific permittivity: 1.6). After a layer with uniform thickness is formed, the thicknesses of the dielectric layers covering the antennas are adjusted. For example, the other antennas are covered by a photoresist using photography, the dielectric layers of the target antennas are etched to the desired thicknesses by wet or dry etching, and the photoresist layer is ultimately removed. The above process is repeated if required.

For example, the dielectric layers can be formed in the following manner. The dielectric layers are fabricated by employing a fabrication method in which discrimination is made between a first sensor group (a group including one or more sensors) that does not need a dielectric layer, a second sensor group in which the adjusting amount of each dielectric layer is small, and a third sensor group in which the adjusting amount of each dielectric layer is large. In the above case, a dielectric layer with a thickness appropriate for the sensor group having the largest adjusting amount is deposited on all the sensors, the sensor group to which adjustment has been completed is masked, and etching is performed while adjusting the etching time so that the needed thickness remains on the sensor group with the smallest adjusting amount. Subsequently, the sensor group with the smallest adjusting amount is masked and the dielectric of the sensor group that does not need a dielectric layer is removed by etching. With the above, dielectric layers with various thicknesses are formed relatively easily. In contrast, the dielectric layers can be formed with a fabrication method in which the dielectric layers are suitably deposited from the sensor group with the smallest adjusting amount.

An example in which the same dielectric material is used while changing the thickness of the dielectric alone has been given above; however, the layer may be formed while changing the thickness, the dielectric material, and the shape, and the like. Furthermore, gray-scale lithography may be used. In such a case, after a dielectric layer with a certain thickness is deposited, photoresist layers with various thicknesses are formed on the antennas such that the thicknesses of the dielectric layers of the antennas can be adjusted by a single etching process. Gray-scale lithography is a method in which a three-dimensional resist shape is obtained by using a special mask called a gray scale mask. The gray scale mask has a gradation in the mask portion. The gradation controls the transmission amount of light. In portions where the transmission amount is large, the resist is exposed to a deep portion and in portions where the transmission amount is small, only the shallow portion of the resist is exposed. By developing the resist that has been exposed in the above manner, a three-dimensional resist shape is obtained. Alternatively, the three-dimensional resist shape can be obtained by not using the gray scale mask but by scanning a light beam while changing the exposure time in a non-uniform manner. Then, by transferring the three-dimensional resist shape to the dielectric material below by RIE or the like, the dielectric layers can be adjusted to various thicknesses according to the antennas. As described above, after forming the photoresist layers with various thicknesses on the antennas, an etchback process is performed by a single dry etching process, for example. In the above process, the photoresist and the dielectric layers are etched at the same etching rate and, as a result, dielectric layers with various thicknesses are formed. These thicknesses correspond to the target corrected resonance frequencies of the antennas.

In the manufacturing method described above, the step of providing dielectric layers that are set to suppress the frequency offsets of the at least two reception/radiation elements includes a step of forming a common dielectric layer on a plurality of reception/radiation elements. The step of providing the set dielectric layers on the at least two reception/radiation elements may include a step of partially etching the common dielectric layer. Furthermore, in the step of forming the common dielectric layer, a portion of the plurality of reception/radiation elements may be masked to form the common dielectric layer. In other words, the step of forming the common dielectric layer on the at least two reception/radiation elements includes coating the plurality of reception/radiation elements including the reception/radiation elements that are to be coated with the common dielectric layers with the dielectric layers, masking, among the plurality of reception/radiation elements, the reception/radiation elements that are to be provided with the common dielectric layers, and etching the dielectric layers while in a state in which the reception/radiation elements that are to be provided with the common dielectric layers are masked.

Other methods may use an ink jet printer or a dispenser to deposit dielectric layers on the antennas. The material of the dielectric layer may be, for example, BCB or epoxy. The permittivity may be adjusted by mixing nano-particles of alumina. When depositing the dielectric material on the plurality of antennas, the deposition amount can be adjusted by changing the parameters of the ink jet printer or the dispenser. However, the accuracy of the deposition thickness may fall behind that of the lithography technique. The dielectric material does not necessarily have to be deposited on the whole of the antenna. There are antennas that do not need any deposition and there are antennas nearby that only require partial deposition. Ultimately, it is only sufficient that the electromagnetic fields near the antennas in which the effective dielectric constants are to be changed are changed.

A second example of the first exemplary embodiment will be described. There are cases in which the thickness range of the dielectric layer is restricted from a practical point of view. In such cases, through combination of various thicknesses and various materials, adjustment of the effective dielectric constant can be performed in a wide range. With the above, the adjustable range of the resonance frequency and the like can be increased. Furthermore, the adjustment of the frequency response characteristic is not limited to adjustment of the resonance frequency. The adjustment through the dielectric layer can be applied to adjustment of frequency response characteristics of nonresonant detectors.

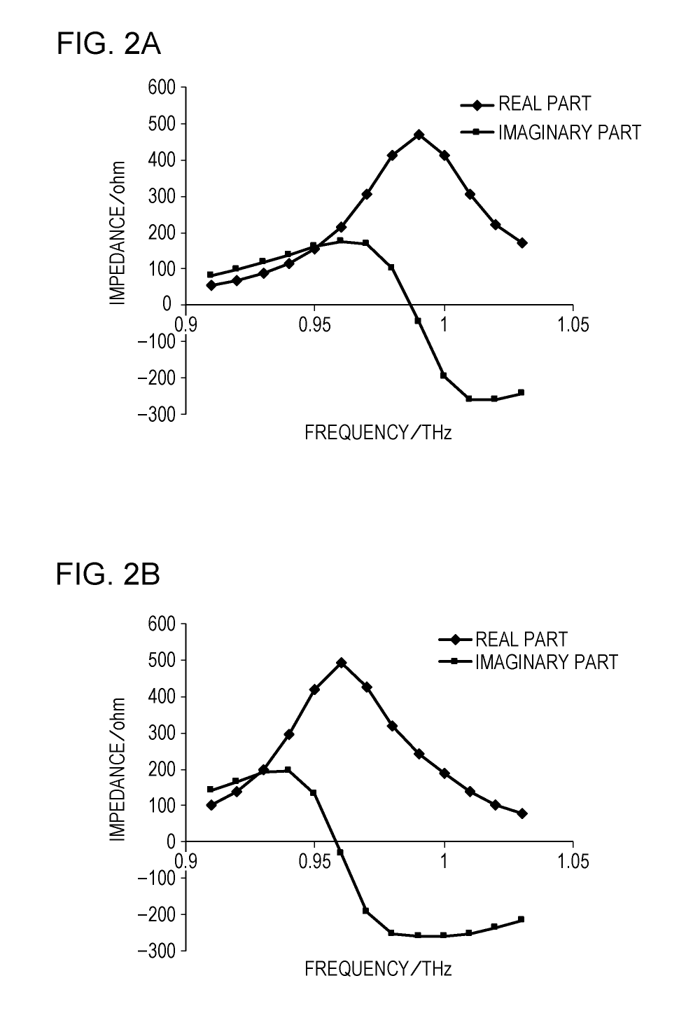

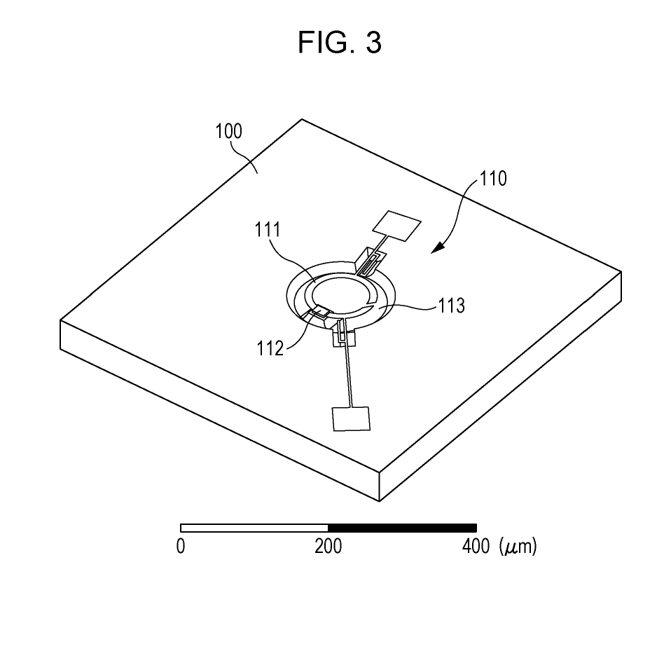

The adjustment performed with the dielectric layer will be described. FIGS. 2A and 2B illustrate simulation results of the radiation impedance of the antenna of the first exemplary embodiment obtained by using commercially available finite element method software HFSS (manufactured by Ansoft). The model of the simulation is illustrated in FIG. 3. In a model having a radiation impedance of FIG. 2A, a coil antenna 111 having a radius of 40 μm is disposed on a metal reflector 113 with a distance of 10 μm. The space between the antenna and the metal reflector is filled with BCB. The antenna is directly connected to an electronic device 112 that is formed on a columnar portion. All of the elements are integrated on the semiconductor substrate 100. In a second model having a radiation impedance of FIG. 2B, the semiconductor substrate 100 is covered uniformly with a BCB layer having a thickness of 1.5 μm. In other words, in the case of the radiation impedance of the antenna illustrated in FIG. 2A, the semiconductor substrate is not coated with a dielectric layer. On the other hand, in the radiation impedance of the antenna of FIG. 2B, the semiconductor substrate is uniformly coated with a BCB layer with a thickness of 1.5 μm. While the resonance frequency is 0.99 THz when no BCB layer is coated, when the antenna is coated with a BCB layer, the resonance frequency shifts to 0.96 THz. A resonance frequency in which the peak of the real part of the impedance is the second antiresonace frequency will now be illustrated.

As can be understood from the manner in which the frequency is shifted, the overall shape and the scale of the frequency response characteristic has not changed. With the method described above, the resonance frequency of the antenna can be changed without greatly changing the overall shape and the amplitude of the frequency response characteristic. Moreover, as described above, the above method is not limited to a resonant system. When the antenna is of a nonresonant type, the frequency response characteristic of the antenna is characterized by the frequency dependency of the reception/radiation pattern and the frequency dependency of the radiation impedance. The above method enables the frequency response characteristic of the antenna to be shifted by a predetermined amount without greatly changing the overall shape and amplitude.

As described above, according to the present exemplary embodiment, an electromagnetic wave detection/generation device in which frequency response characteristics of antennas of a plurality of reception/radiation elements integrated on a single semiconductor substrate are suitably adjusted, for example, can be fabricated. Furthermore, there is no need to separately adjust the frequency response characteristics of the antennas of the plurality of reception/radiation elements and fabrication thereof is relatively easy.

### Second Exemplary Embodiment

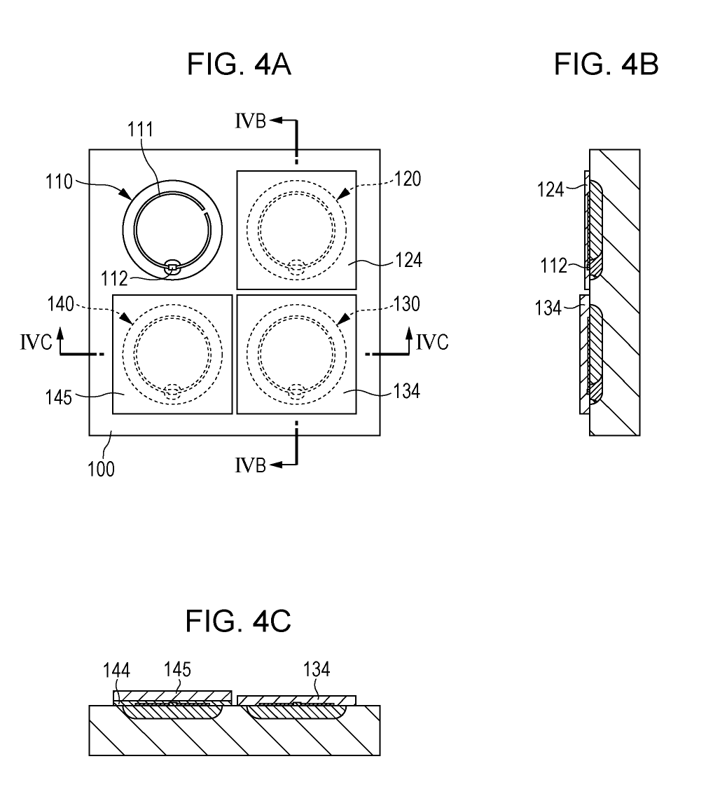

A second exemplary embodiment will be described. In the second exemplary embodiment, layers of a plurality of dielectric materials with various thicknesses are disposed. Each layer is used as a layer to provide an effective dielectric constant that corresponds to the frequency correction. Furthermore, the above layers may be used in combination to correspond to a further frequency correction. Referring to FIG. 4A, a configuration of an electromagnetic wave detection/generation device of a first example of the present exemplary embodiment is illustrated. Referring further to FIG. 4B, a cross-section taken along IVB-IVB of the electromagnetic wave detection/generation device of the first example is illustrated, and referring to FIG. 4C, a cross-section taken along IVC-IVC of the electromagnetic wave detection/generation device of the first example is illustrated. The semiconductor substrate 100 is provided with an array of sensors for a terahertz range. Each sensor includes an antenna, an electronic device, and a reflector. The sensor 120 is coated with the dielectric layer 124 that has a thickness of t1 and, as a result, a first effective dielectric constant is obtained. The sensor 130 is coated with the dielectric layer 134 that has a thickness of t2 and, as a result, a second effective dielectric constant is obtained. The sensor 140 is coated with a dielectric layer 144 with a thickness of t1 and a dielectric layer 145 with a thickness of t2 and, as a result, is coated with a dielectric layer that has a thickness of t3=t1+t2 such that a third effective dielectric constant is obtained. The sensor 110 is not coated with a dielectric layer and the resonance frequency is at its original frequency.

An exemplary fabrication method will be described. A first dielectric layer with a thickness of t1 is deposited across the whole surface of the substrate. By photolithography and wet or dry etching, the dielectric layer is removed from the sensors 110 and 130. Subsequently, a second dielectric layer with a thickness of t2 is deposited across the whole surface of the substrate. By photolithography and wet or dry etching, the second dielectric layer is removed from the sensors 110 and 120. As a result, a structure illustrated in FIGS. 4A to 4C is fabricated. In the first example, since the dielectric layers that have different thicknesses but are of the same material are bonded together, three effective dielectric constants can be obtained with just two processes. More generally, with the above method, at the most, 2″ number of thicknesses that are different from each other can be obtained by combining layers with n types of thicknesses. When the thicknesses of all the layers are different from each other, the number of types of thicknesses becomes maximum.

There is a second example that uses a plurality of materials to broaden the scope of application of the second exemplary embodiment. In the first example, the dielectric layers that cover different antennas are formed of a single material but with different thicknesses; however, in the second example, different materials are used. In the second example, in order to create a wider variety in the difference in the effective dielectric constants, various materials are used for the dielectric layers that cover different antennas. Various materials with various thicknesses are bonded and used as the dielectric layers. For example, an antenna of a certain sensor is coated by a layer formed of a predetermined dielectric material and with a predetermined thickness so as to obtain a predetermined effective dielectric constant. Another sensor is coated by a layer formed of a different dielectric material and with a different thickness so as to obtain a second effective dielectric constant. Last of all, an antenna of a third sensor is coated by both of the layers so as to obtain a third effective dielectric constant. By using and coating two different dielectric layers, three different effective dielectric constants can be obtained as in the first example. The above combinations can be increased even further.

As described above, according to the present exemplary embodiment, an electromagnetic wave detection/generation device in which frequency response characteristics of antennas of a plurality of reception/radiation elements integrated on a single semiconductor substrate are suitably adjusted, for example, can be fabricated.

### Third Exemplary Embodiment

The first and second exemplary embodiments provide image sensors in which the frequency response characteristics (the resonance frequencies) of antennas for a terahertz range are adjusted to target values and in which a plurality of types of dielectric layer with a plurality of thicknesses and/or of a plurality of materials are used. Accordingly, the fabrication process tends to become complicated. A third exemplary embodiment overcomes the above point.

When an electromagnetic wave propagates through a non-uniform dielectric medium in which the change distributions of the size and permittivity are smaller than the wave length of the propagation wave (typically equivalent to or smaller than 1/10), the electromagnetic wave behaves as if propagating through a dielectric medium with a certain effective dielectric constant. The value of the effective dielectric constant is dependent on the permittivity, the size, and the shape (the width of the stripe-shaped dielectric material, the interval between the stripe-shaped dielectric materials, etc.) of the dielectric area.

In the third exemplary embodiment, the fabrication process can be one that uses a relatively simple semiconductor technology when there are various frequency offsets and when many antennas are used. In the principle of the above, the above-described method of obtaining the effective dielectric constant is used. Rather than or in addition to obtaining the target effective dielectric constant by adjusting the permittivity and thickness of the layer covering the antenna, correction of the frequency response characteristic of the antenna is performed by coating the antenna with a non-uniform dielectric material and using the non-uniformity to adjust the effective dielectric constant.

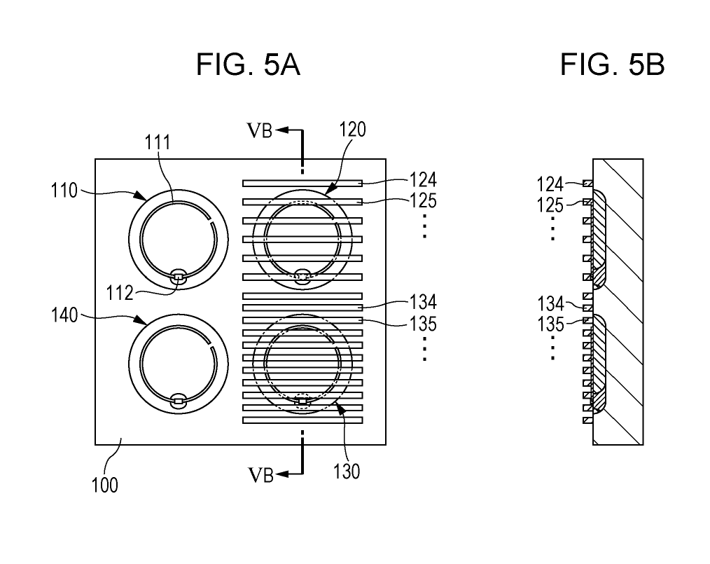

In FIG. 5A, a plan view describing a configuration of an electromagnetic wave detection/generation device of a first example of the third exemplary embodiment is illustrated. Furthermore, FIG. 5B illustrates a cross-sectional view taken along VB-VB of the electromagnetic wave detection/generation device of the first example. The semiconductor substrate 100 is provided with an array of antennas for a terahertz range. Each sensor includes an antenna, an electronic device, and a reflector. The second sensor 120 is coated with stripes 124, 125 , . . . , and so on. The coverage ratio (the coating ratio (surface area coating ratio)) of the above is 30%. From the viewpoint of the antenna, the effective dielectric constant is dependent on the permittivity of the material of the stripes, the thickness of the stripes, and the coverage ratio of the stripes. The third sensor 130 is coated with stripes 134, 135 , . . . , and so on that are formed of the same material and with the same thickness. The coverage ratio of the above is 50%. As a result, the effective dielectric constant from the viewpoint of the antenna of the third sensor 130 is different from the effective dielectric constant from the viewpoint from the antenna of the second sensor 120. The first sensor 110 and the fourth sensor 140 are not changed.

A fabrication process of the first example of the present exemplary embodiment will be described. The semiconductor substrate is uniformly coated with a dielectric layer with a predetermined thickness. The dielectric layer of each antenna needs to be adjusted until the effective dielectric constant corresponding to the frequency offset is reached. Here, adjustment to the coverage ratio that corresponds to the frequency offset of the relevant sensor needs to be made. By photolithography and wet or dry etching, the dielectric layer is patterned to form stripes such that dielectric layers having desired coverage ratios are fabricated. As a result, various effective dielectric constants can be obtained with a single dielectric material and a single dielectric layer with a single thickness. The various effective dielectric constants are obtained through patterning of the dielectric layer with various coverage ratios. The above fabrication method is easier compared with the lithography technique that uses various materials with various thicknesses.

The third exemplary embodiment can also have a second example. Herein, layers with various permittivities and various thicknesses are used. As a result, adjustment of the effective dielectric constants can be made in a further wider range.

According to the present exemplary embodiment, an electromagnetic wave detection/generation device in which frequency response characteristics of antennas of a plurality of reception/radiation elements integrated on a single semiconductor substrate are suitably adjusted, for example, can be fabricated.

### Fourth Exemplary Embodiment

In the exemplary embodiments described above, in order to orient the reception/radiation pattern mainly towards the outer direction with respect to the semiconductor substrate, a reflector that is distanced away from the antenna is provided. However, compared to a case in which no reflector is provided, when a reflector is integrated in the semiconductor substrate, the fabrication cost increases. As described above, since the permittivity of the substrate material is by far greater than the permittivity of the air surrounding the substrate, the reception/radiation pattern is oriented mainly towards the inside of the semiconductor substrate when, without providing any reflector, an antenna is directly provided on the semiconductor substrate.

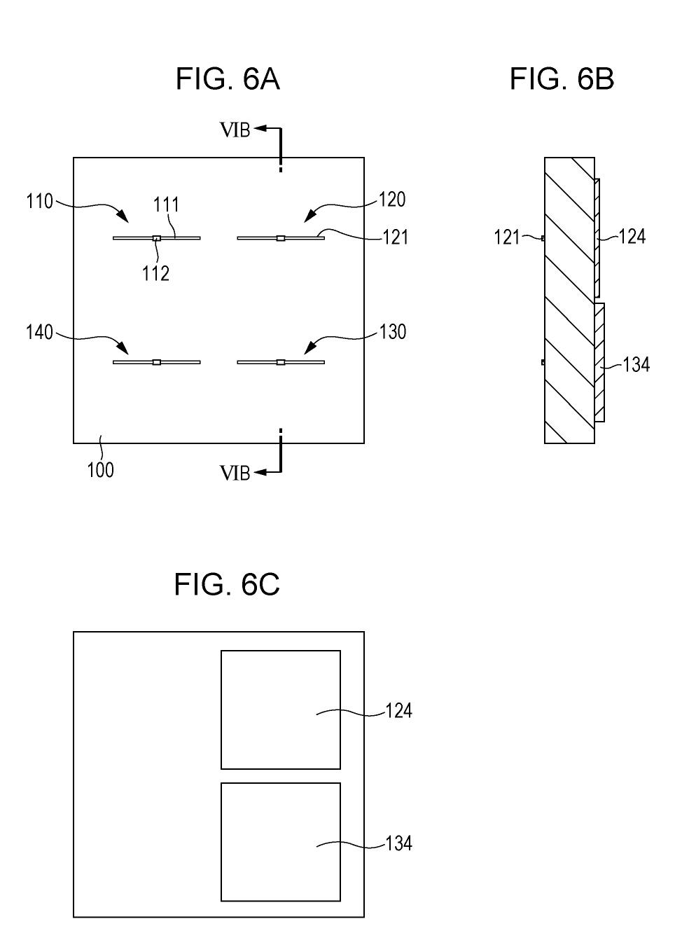

In the fourth exemplary embodiment, the resonance frequencies of the sensors provided on a semiconductor substrate integrated with no reflector are adjusted. In FIG. 6A, a plan view describing a front side configuration of an electromagnetic wave detection/generation device of the present exemplary embodiment is illustrated. Furthermore, FIG. 6B illustrates a cross-sectional view taken along VIB-VIB of FIG. 6A. Here, a plurality of sensors 110, 120, 130, and 140 are integrated on the semiconductor substrate 100 of the image sensor. In one example, the sensors each include a dipole antenna 111 and an electronic device 112 that is directly connected to the antenna. In FIG. 6A, reference numerals are attached only to the dipole antenna 111 and the electronic device 112 of the sensor 110; however, the same applies to the other sensors. In FIG. 6C, a bottom view describing a back surface configuration of the electromagnetic wave detection/generation device of the present exemplary embodiment is illustrated. In the sensor 120, the back surface of the semiconductor substrate is coated with the dielectric layer 124, and in the sensor 130, the back surface of the semiconductor substrate is coated with the dielectric layer 134. In the above example, since the frequency offsets of the sensors 110 and 120 are different with respect to each other, the thicknesses of the layers 124 and 134 are different with respect to each other. For example, while the thicknesses are the same, the dielectric materials may be made different or the shape patterns may be made different.

As described above, in the electromagnetic wave detection/generation device of the present exemplary embodiment, the plurality of reception/radiation elements are provided on one surface side of the substrate. Furthermore, at least one of the reception/radiation elements includes a dielectric layer that has a function of adjusting the frequency response characteristic of the antenna of the reception/radiation element and that is formed on the other surface of the substrate that is on the opposite side of the one surface.

According to the present exemplary embodiment, an electromagnetic wave detection/generation device in which frequency response characteristics of antennas of a plurality of reception/radiation elements integrated on a single semiconductor substrate are suitably adjusted, for example, can be fabricated.

In a fifth exemplary embodiment, a method for adjusting or correcting the frequency response characteristics of the image sensors of the exemplary embodiments described above will be described. A first example of the fabrication method is of a feedback type. First, the target frequency of each sensor is determined. Subsequently, a sensor array is fabricated on a planar semiconductor substrate. The difference in parameters during the fabrication process is due to the difference in the target frequencies of the sensors. The frequency response characteristic of each sensor is measured by sequentially irradiating an electromagnetic wave on each sensor. The frequency response characteristic of each sensor is measured by changing an oscillation frequency of a radiation device having a known frequency characteristics at a predetermined interval. The frequency offset of each sensor is calculated as the difference between the measured frequency and the target frequency.

Next, the effective dielectric constant of each sensor that corresponds to the above difference and that is caused by the dielectric layer is determined. The determination is performed in the following manner, for example. Experiment results that have been accumulated as a database is used. The database is constructed using test specimens. A plurality of dielectric layers of various materials, thicknesses, and shapes are deposited to experimentally evaluate the effects of the effective dielectric constant of the layers with respect to the frequency response characteristic of the sensor. In determining the required characteristics of the deposited dielectric layer, there are other methods such as a method using simulation. For example, HFSS and the simulation illustrated in the exemplary embodiment described above can be used to obtain effects that the dielectric layers of various characteristics that cover the sensors exert on the frequency response characteristics of the sensors.

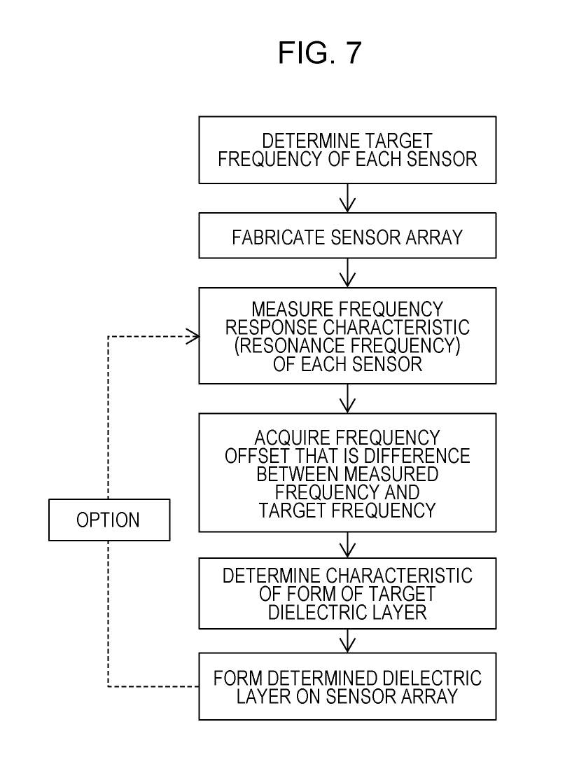

In each of the sensors, if the material, the thickness, and the shape of the dielectric layer are clear, then the processes described above are performed on the semiconductor substrate. If necessary, the frequency response characteristic (the resonance frequency) of each sensor is measured once more, the frequency offset is calculated once more, and a new target characteristics of the dielectric layer is determined, so as to readjust the dielectric layer of each sensor. By adjusting the characteristics of the dielectric layer for a number of times, it will be possible to reach the target frequency response characteristic (the resonance frequency) with a higher accuracy compared with the accuracy reached through a single adjustment. A flowchart of the fabricating method of the first example is illustrated in FIG. 7.

A second example of the fabrication method is of a feedforward type. Variation during semiconductor production is basically caused by two causes, and the above method is applicable. The variation caused by one of the causes is due to errors in the set values of the process parameters such as the temperature and the process gas pressure. The variation thereof is random and can be modeled and estimated only through a statistical method. The variation caused by the other one of the causes has reproducibility. The variation is a spatial variation of the process parameters across the entire wafer. For example, during dry etching inside a vacuum chamber, the variation is caused by the position of the process gas inlet, the size and shape of the etching chamber, and the electromagnetic distribution inside the etching chamber, which have an effect on the etching distribution across the entire substrate. The variation is uniform irrespective of the substrate that is the subject of the process. As a result, if the variation is known, then, there is no need to measure the frequency response characteristic of each of the image sensors each time. The variation obtained by measuring one wafer is repeated. As a result, there is no need to measure the frequency response characteristic (the resonance frequency) of each sensor in order to obtain the frequency offsets that are to be corrected in each of the substrates.

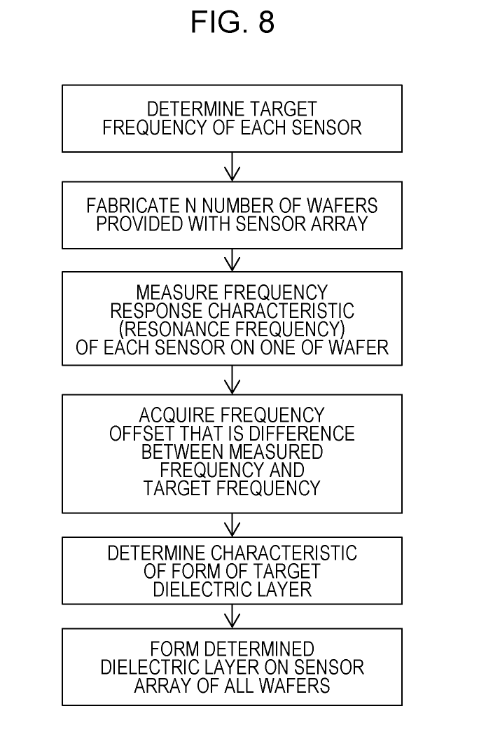

The second example will be described. First, the target frequency of each sensor is determined. Next, a plurality of wafers each including a sensor array are fabricated. The frequency response characteristic (the resonance frequency) of each sensor on one of the wafers are measured with a method that is similar to that described in the first example described above. The offset frequency that is a difference between the target frequency and the measured frequency is calculated for each sensor. Next, the characteristics of the form of the target dielectric layer is determined by the method described in the first example described above, that is, by using the experiment data or the simulation results. Last of all, dielectric layers having the determined form is formed in a similar manner in all of the wafers without measuring the frequency response characteristic (the resonance frequency) of each of the wafers. With the above method, the processes of all of the wafers can be performed swiftly, and it can be said that the method is one that is more economical. A flowchart of the fabricating method of the second example is illustrated in FIG. 8.

Since the oscillator and the receiver that use the antenna are equivalent, the exemplary embodiments above can be applied to electromagnetic wave generation devices as well. In other words, due to the equivalence between the electromagnetic wave generation device and the electromagnetic wave detection device that use the antenna, each of the examples of the sensors described above can be applied to or put to practical use in electromagnetic wave generation devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-154354, filed Jul. 29, 2014, which is hereby incorporated by reference herein in its entirety.

What is claimed is:

1. An electromagnetic wave detection/generation device, comprising:
a substrate; and
a plurality of reception/radiation elements provided on the substrate, wherein
the plurality of reception/radiation elements each include an antenna and an electronic device;
at least two of the reception/radiation elements are coated at least partially with dielectric layers, the dielectric layers each having a function of adjusting a frequency response characteristic of the antenna of the corresponding one of the reception/radiation elements, and
at least two of the dielectric layers are different with respect to each other in at least either one of thickness, material, shape, and coating ratio.

2. The electromagnetic wave detection/generation device according to claim 1, wherein
the at least two of the dielectric layers include
a first dielectric layer,
a second dielectric layer that is different from the first dielectric layer in at least either one of thickness and material, or
a third dielectric layer in which the first dielectric layer and the second dielectric layer superpose each other.

3. The electromagnetic wave detection/generation device according to claim 1, wherein
the at least two of the dielectric layers include one or more dielectric layers that are adjusted so that thicknesses thereof are different from each other.

4. The electromagnetic wave detection/generation device according to claim 1, wherein
the at least two of the dielectric layers include dielectric layers that are of a same material and that are different with respect to each other in at least either one of thickness, shape, and coating ratio.

5. The electromagnetic wave detection/generation device according to claim 1, wherein
the at least two of the dielectric layers each include a plurality of stripe-shaped dielectric materials, and
in the at least two of the dielectric layers, coating ratios are different from each other.

6. The electromagnetic wave detection/generation device according to claim 5, wherein
widths of the stripe-shaped dielectric materials and intervals between the stripe-shaped dielectric materials are equivalent to or smaller than 1/10 of a wave length of an operating electromagnetic wave.

7. The electromagnetic wave detection/generation device according to claim 1, wherein
the reception/radiation elements each include a metal reflector that is provided in a portion of the substrate that is under the antenna.

8. The electromagnetic wave detection/generation device according to claim 1, wherein
each of the dielectric layers totally covers the corresponding antenna.

9. The electromagnetic wave detection/generation device according to claim 1, wherein
the frequency response characteristic is a resonance frequency.

10. An electromagnetic wave detection/generation device, comprising:
a substrate; and
a plurality of reception/radiation elements provided on one surface side of the substrate, wherein
the plurality of reception/radiation elements each include an antenna and an electronic device;
at least one of the reception/radiation elements includes a dielectric layer that has a function of adjusting a frequency response characteristic of the antenna of the reception/radiation element and that is formed on the other surface of the substrate that is on the opposite side of the one surface.

11. The electromagnetic wave detection/generation device according to claim 10, wherein
the frequency response characteristic is a resonance frequency.

12. A method for manufacturing an electromagnetic wave detection/generation device including a plurality of reception/radiation elements that are provided on a substrate and that each include an antenna, the method comprising:
determining target frequency response characteristics of the reception/radiation elements;
fabricating the plurality of reception/radiation elements on the substrate;
measuring frequency response characteristics of the reception/radiation elements;
obtaining frequency offsets between the target frequency response characteristics and the measured frequency response characteristics;
determining at least either one of thicknesses, materials, shapes, and coating ratios of dielectric layers that are needed to reduce the frequency offsets, the dielectric layers each being provided at least partially on the corresponding one of at least two of the reception/radiation elements; and
providing, at least partially, the determined dielectric layers on the at least two of the reception/radiation elements.

13. A method for manufacturing an electromagnetic wave detection/generation device including a plurality of reception/radiation elements that are provided on a substrate and that each include an antenna, the method comprising:
determining target frequency response characteristics of the reception/radiation elements;
fabricating a plurality of wafers that each include a plurality of reception/radiation elements;
measuring frequency response characteristics of the reception/radiation elements of a single wafer among the plurality of wafers;
obtaining frequency offsets between the target frequency response characteristics and the measured frequency response characteristics;
determining at least either one of thicknesses, materials, shapes, and coating ratios of dielectric layers that are needed to reduce the frequency offsets of the single wafer, the dielectric layers each being provided at least partially on the corresponding one of at least two of the reception/radiation elements; and
providing, at least partially, the determined dielectric layers on the at least two of the reception/radiation elements of all of the plurality of wafers.

14. The method for manufacturing the electromagnetic wave detection/generation device according to claim 12, wherein
among the determined dielectric layers, at least one of group of dielectric layers with same thickness and same material is provided within the same step.

15. The method for manufacturing the electromagnetic wave detection/generation device according to claim 13, wherein
among the determined dielectric layers, at least one of group of dielectric layers with same thickness and same material is provided within the same step.

16. The method for manufacturing the electromagnetic wave detection/generation device according to claim 14, wherein
the providing of the dielectric layers, among the determined dielectric layers, that have the same thickness and the same material includes
coating the plurality of reception/radiation elements with the dielectric layers that have the same thickness and the same material,
masking, among the plurality of reception/radiation elements, the reception/radiation elements that are to be provided with the dielectric layers that have the same thickness and the same material, and
etching the dielectric layers while in a state in which the reception/radiation elements that are to be provided with the dielectric layers that have the same thickness and the same material are masked.

17. The method for manufacturing the electromagnetic wave detection/generation device according to claim 15, wherein
the providing of the dielectric layers, among the determined dielectric layers, that have the same thickness and the same material includes
coating the plurality of reception/radiation elements with the dielectric layers that have the same thickness and the same material,
masking, among the plurality of reception/radiation elements, the reception/radiation elements that are to be provided with the dielectric layers that have the same thickness and the same material, and
etching the dielectric layers while in a state in which the reception/radiation elements that are to be provided with the dielectric layers that have the same thickness and the same material are masked.

18. The method for manufacturing the electromagnetic wave detection/generation device according to claim 12, wherein
the determined dielectric layers are formed by using gray-scale lithography.

19. The method for manufacturing the electromagnetic wave detection/generation device according to claim 13, wherein
the determined dielectric layers are formed by using gray-scale lithography.

20. The method for manufacturing the electromagnetic wave detection/generation device according to claim 12, wherein
the dielectric layers are formed with a dispenser or an ink jet printer.

21. The method for manufacturing the electromagnetic wave detection/generation device according to claim 13, wherein
the dielectric layers are formed with a dispenser or an ink jet printer.
